(19) United States
(12) Patent Application Publication
(10) Pub. No.: US 2024/0305861 A1
(43) Pub. Date: Sep. 12, 2024

(54) VIDEO-BASED INFORMATION DISPLAY METHOD AND APPARATUS, AND ELECTRONIC DEVICE AND STORAGE MEDIUM

(71) Applicant: Beijing Youzhuju Network Technology Co., Ltd., Beijing (CN)

(72) Inventors: Ying HUANG, Beijing (CN); Menglin ZHANG, Beijing (CN); Liangcheng XU, Beijing (CN)

(21) Appl. No.: 18/573,143

(22) PCT Filed: Sep. 15, 2022
(86) PCT No.: PCT/CN2022/119056

§ 371 Date: Dec. 21, 2023

(30) Foreign Application Priority Data
Sep. 27, 2021 (CN) 202111139750.3

(51) Int. Cl. H04N 21/472; G06F 16/735; G06F 16/738; H04N 21/431; H04N 21/44

(52) U.S. Cl. CPC H04N 21/47217; G06F 16/735; G06F 16/739; H04N 21/4316; H04N 21/44008

(57) ABSTRACT

A video-based information display method and apparatus, and an electronic device and a storage medium. The video-based information display method includes: in response to triggering a first event on a first page playing a target video, acquiring first resource information corresponding to a target object in a first image frame; switching to a second page, the first image frame being displayed in an image display region of the second page, and the first resource information being displayed in a resource information region of the second page; in response to triggering a second event for adjusting a playing progress of the target video, switching from displaying the first image frame to displaying a second image frame of the target video, and acquiring second resource information corresponding to a target object in the second image frame; and displaying the second resource information in the resource information region.

The present application claims the priority of Chinese Patent Application No. 202111139750.3 filed on Sep. 27, 2021, and the above Chinese Patent Application is incorporated herein by reference in its entirety as part of the present application.

### TECHNICAL FIELD

Embodiments of the present disclosure relate to a video-based information display method and apparatus, an electronic device and a storage medium.

### BACKGROUND

In order to facilitate a user to search for relevant resources in a picture, some applications provide an image recognition and search function. The user may upload the picture to the application, and the application can recognize the picture and search for relevant resources according to a recognition result, and provide the relevant resources to the user. When the user wants to search for resources in a video while watching the video, the user may trigger the image recognition and search function in a video playing process.

### SUMMARY

In a case where image recognition and search operation is required for different image frames of a video, it is necessary to return to a video playing page every time to trigger image recognition and search operation, resulting in complicated operations and poor user experience. In view of the above problems, at least one embodiment of the present disclosure provides a video-based information display method and apparatus, an electronic device and a storage medium, which can simplify an operation flow, improve the efficiency and enhance the user experience when image recognition and search operation are required for different image frames of the video.

At least one embodiment of the disclosure provides a video-based information display method, including: in response to triggering a first event on a first page playing a target video, acquiring first resource information corresponding to a target object in a first image frame based on at least one first image frame played in a process of triggering the first event; switching to a second page, in which the second page includes an image display region and a resource information region, the first image frame is displayed in the image display region, and the first resource information is displayed in the resource information region; in response to triggering, on the second page, a second event for adjusting a playing progress of the target video, switching from displaying the first image frame in the image display region to displaying a second image frame of the target video in the image display region, and acquiring second resource information corresponding to a target object in the second image frame; and displaying the second resource information in the resource information region.

At least one embodiment of the disclosure provides a video-based information display apparatus, including a first resource module, a first display module, a second resource module, and a second display module, the first resource module is configured to, in response to triggering a first event on a first page playing a target video, acquire first resource information corresponding to a target object in a first image frame based on at least one first image frame that is played in a process of triggering the first event; the first display module is configured to switch to a second page, in which the second page includes an image display region and a resource information region, the first image frame is displayed in the image display region, and the first resource information is displayed in the resource information region; the second resource module is configured to, in response to triggering, on the second page, a second event for adjusting a playing progress of the target video, switch from displaying the first image frame in the image display region to displaying a second image frame of the target video in the image display, and acquire second resource information corresponding to a target object in the second image frame; and the second display module is configured to display the second resource information in the resource information region.

At least one embodiment of the disclosure provides an electronic device including a processor; and a memory including one or more computer program modules; the one or more computer program modules are stored in the memory and configured to be executed by the processor, and the one or more computer program modules include instructions for implementing the video-based information display method according to any one embodiment of the present disclosure.

At least one embodiment of the disclosure provides a computer-readable storage medium for storing non-transitory computer-readable instructions, the non-transitory computer-readable instructions, when executed by a computer, implement the video-based information display method according to any one embodiment of the present disclosure.

At least one embodiment of the disclosure provides a computer program product including a computer program carried on a non-transient computer-readable medium, the computer program including program codes for executing the video-based information display method according to any one embodiment of the present disclosure.

### BRIEF DESCRIPTION OF THE DRAWINGS

The above-described and other features, advantages and aspects of the respective embodiments of the present disclosure will become more apparent when taken in conjunction with the accompanying drawings and with reference to the detailed description below. Throughout the drawings, same reference signs refer to same elements. It should be understood that, the drawings are schematic and that originals and elements are not necessarily drawn to scale.

FIG. 1 is a flow diagram of a video-based information display method provided by some embodiments of the present disclosure;

FIG. 2 is a schematic diagram of a first page provided by some embodiments of the present disclosure;

FIG. 3A is a schematic diagram of a second page provided by some embodiments of the present disclosure;

FIG. 3B is a schematic diagram of another second page provided by some embodiments of the present disclosure;

FIG. 4 is a schematic diagram of another second page provided by some embodiments of the present disclosure;

FIG. 5A is a schematic diagram of another first page provided by some embodiments of the present disclosure;

FIG. 5B is a schematic diagram of another first page provided by some embodiments of the present disclosure;

FIG. 6 is a schematic diagram of another second page provided by some embodiments of the present disclosure;

FIG. 7 is a schematic diagram of another second page provided by some embodiments of the present disclosure;

FIG. 8A is a schematic diagram of another second page provided by some embodiments of the present disclosure;

FIG. 8B is a schematic diagram of another second page provided by some embodiments of the present disclosure;

FIG. 9 is a schematic diagram of another second page provided by some embodiments of the present disclosure;

FIG. 10 is a schematic diagram of a system used to implement the video-based information display method provided by the embodiment of the present disclosure;

FIG. 11 is a schematic block diagram of a video-based information display apparatus provided by some embodiments of the present disclosure;

FIG. 12 is a schematic block diagram of an electronic device provided by some embodiments of the present disclosure;

FIG. 13 is a schematic block diagram of another electronic device provided by some embodiments of the present disclosure; and

FIG. 14 is a schematic diagram of a storage medium provided by some embodiments of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure may be embodied in various forms and should not be construed as limited to the embodiments set forth here, On the contrary, these embodiments are provided for a more thorough and complete understanding of the present disclosure. It should be understood that the drawings and the embodiments of the present disclosure are only for illustration purposes, and are not intended to limit the protection scope of the present disclosure.

It should be understood that the steps described in the method embodiments of the present disclosure may be performed in a different order and/or in parallel. In addition, the method embodiments may include additional steps and/or omit the steps shown. The scope of the present disclosure is not limited in this respect.

As used herein, the term “comprising” and its variations are open including, that is, “including but not limited to”. The term “based on” means “at least partially based on”. The term “one embodiment” means “at least one embodiment”; the term “another embodiment” means “at least one other embodiment”; and the term “some embodiments” means “at least some embodiments”. Relevant definitions of other terms will be given in the following description.

It should be noted that the concepts of “first” and “second” mentioned in the disclosure are only used to distinguish devices, modules or units, and are not used to limit that these devices, modules or units must be different devices, modules or units, nor to limit the order or interdependence of the functions performed by these devices, modules or units.

It should be noted that the modification “one” and “a plurality” mentioned in this disclosure are illustrative rather than restrictive, and those skilled in the art should understand that unless the context clearly indicates otherwise, they should be understood as “one or more”. “a plurality” should be understood to mean two or more.

The names of interactive messages or information between a plurality of devices in the embodiment of the present disclosure are for illustrative purposes only and should not restrict the scope of the messages or information.

In some cases, a user may need to perform image recognition and search operation on different image frames of a video. For example, the video includes an image frame A and an image frame B, which respectively include two types of content of interest to the user. When the video is played to the image frame A of the video, the image recognition and search operation for the image frame A may be triggered, and then a corresponding search result is displayed to the user. However, when the user wants to perform the image recognition and search operation on the image frame B, it is necessary to return to the video playing page again, and then the image recognition and search operation for the image frame B are triggered when the video is played to the image frame B. In this way, in a case where the image recognition and search operation is required for different image frames of a video, it is necessary to return to the video playing page every time to trigger image recognition and search operation, resulting in complicated operation and poor user experience.

At least one embodiment of the present disclosure provides a video-based information display method and apparatus, an electronic device and a storage medium, which can simplify operation flow, improve the efficiency and enhance the user experience when image recognition and search are required for different image frames of a video.

Hereinafter, embodiments of the present disclosure will be described in detail with reference to the accompanying drawings.

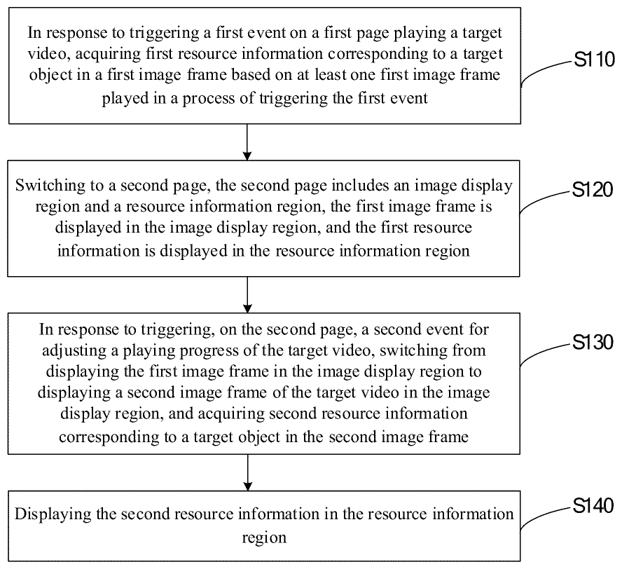

FIG. 1 is a flow diagram of a video-based information display method provided by some embodiments of the present disclosure. As shown in FIG. 1, in at least one embodiment, the video-based information display method includes steps S110 to S140.

Step S110: in response to triggering a first event on a first page playing a target video, acquiring first resource information corresponding to a target object in a first image frame based on at least one first image frame played in a process of triggering the first event.

Step S120: switching to a second page, the second page includes an image display region and a resource information region, the first image frame is displayed in the image display region, and the first resource information is displayed in the resource information region.

Step S130: in response to triggering, on the second page, a second event for adjusting a playing progress of the target video, switching from displaying the first image frame in the image display region to displaying a second image frame of the target video in the image display region, and acquiring second resource information corresponding to a target object in the second image frame.

Step S140: displaying the second resource information in the resource information region.

For example, the video-based information display method of the embodiment of the present disclosure may be executed by a terminal device, the terminal device includes but not limited to a mobile phone, a tablet computer, a notebook computer and the like. The terminal device may include a display apparatus, a processor, a data transceiver and the like, and the terminal device may transmit data with a server and/or a database through a communication network.

For example, the target video may be a short video, a long video, a live video and other video media resources. The target video may be uploaded to a corresponding platform (for example, an application) by the terminal device, and the target video may be stored in the server and/or the memory of the platform. A terminal that uploads the target video (for example, a terminal device, a client and a user) may be the same as or different from a terminal that plays the target video (for example, a terminal device, a client and a user). For example, after a first user uploads a target video to a platform (for example, a server side) through a first terminal device, the platform may, in response to a request, push the target video to a second terminal device to play, so as to be viewed by a second user of the second terminal device.

For example, the target object may include an item, a person, an animal and other object appearing in the video, and the resource information (for example, the first resource information and the second resource information) may be recommendation information about the target object or explanatory information about the target object. In some examples, in a case where the target object is an item (for example, a commodity, an exhibit, etc.), the resource information may be item recommendation information corresponding to the item or explanatory information about the item, etc. In other examples, in a case where the target object is a person, the resource information may be explanatory information about the person. In the following embodiments, taking the target object as an item and the resource information as item recommendation information as an example for illustration, but the embodiment of the present disclosure is not limited to this, and in the actual application process, the types of the target object and the resource information may be set according to actual requirements.

For example, in step S110, the first page is a playing page of the target video, and the target video is displayed in at least partial region of the first page, and operations such as pause, play, screenshot and the like may be triggered on the first page. When the first event is triggered in the process of playing the target video on the first page, online image recognition and search operation may be performed for an image frame (namely, the first image frame) being played when the first event is triggered.

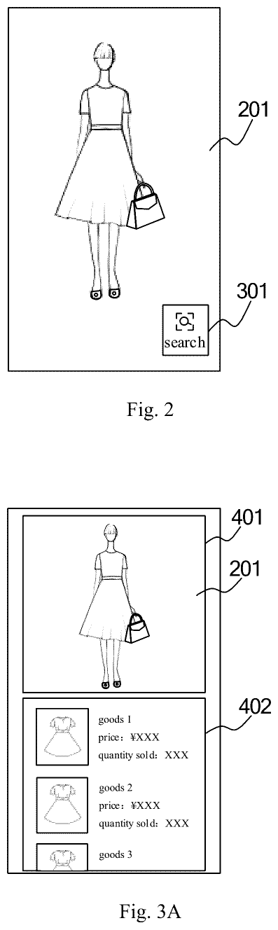

FIG. 2 is a schematic diagram of a first page provided by some embodiments of the present disclosure. As shown in FIG. 2, for example, the target video may be displayed on the first page, and a situation that the target video is played to the image frame 201 is shown in the figure. A control 301 may also be displayed in the first page, and the control 301 may be an example of the “first control” of the present disclosure. The first event may include triggering a first predetermined operation on the control 301 in a process of playing the target video. In some examples, the first predetermined operation may be a click operation, and in other examples, the first predetermined operation may be a double-click operation, a swipe operation, etc., and the specific form of the first predetermined operation is not limited to the embodiment of the present disclosure.

For example, in the case where it is detected that the user has performed the first predetermined operation on the control 301 while the target video is played to the image frame 201, the first event is considered to be triggered, and the current image frame 201 is regarded as a first image frame, and online image recognition and search operation may be performed on the image frame 201. The image frame 201 is taken as an example of the “first image frame” in the present disclosure below. For example, the terminal device may send the image frame 201 to the server, and the server performs the image recognition and search operation for the image frame 201 to obtain first resource information and feeds back the first resource information to the terminal device. In other examples, the image recognition and search operation may also be performed in the terminal device.

For example, the recognition operation on the image frame 201 may be performed by using a pre-trained object recognition model, and the object recognition model may be a neural network model, a deep learning model, a classification tree model or other types of models. In a process of training the object recognition model, the object recognition model may be trained to be able to recognize a category and features of the target object in the image frame. For example, in a case where the image frame 201 includes a target object “skirt”, by using the object recognition model, the type of the target item may be recognized as a skirt, and the features of the skirt such as color, length, material and texture may be recognized. For example, P target objects may be recognized (P is an integer greater than or equal to 1) for each image frame. When the number of recognized target objects is greater than P, P main target objects may be determined according to conditions such as area ratio or coordinate position of each target object.

For example, after the P target objects of the first image frame are obtained, a search operation may be performed in a predetermined network platform based on a recognition result of each target object, to obtain resource information matched with each target object as the first resource information. For example, in the case where the recognition result of a certain target object in the image frame 201 is a long yellow skirt, the search may be performed in a predetermined shopping platform according to keywords such as “yellow” and “long skirt” to obtain Q pieces of item information matched with the target object (Q is an integer greater than or equal to 1). In some examples, in the case where the number of pieces of searched item information is greater than Q, Q pieces of preferred item information may be filtered out from search results based on conditions such as sales volume and favorable rating.

For example, in the case where P target objects are recognized from the first image frame and Q pieces of resource information are searched for each target object, P*Q pieces of resource information may be obtained, and the P*Q pieces of resource information may be used as the first resource information. For the sake of distinction, each piece of resource information in the first resource information is referred to as first sub-resource information hereinafter.

For example, in step S120, after the terminal device acquires the first resource information, the terminal device may switch from the first page to a second page to display the first resource information on the second page.

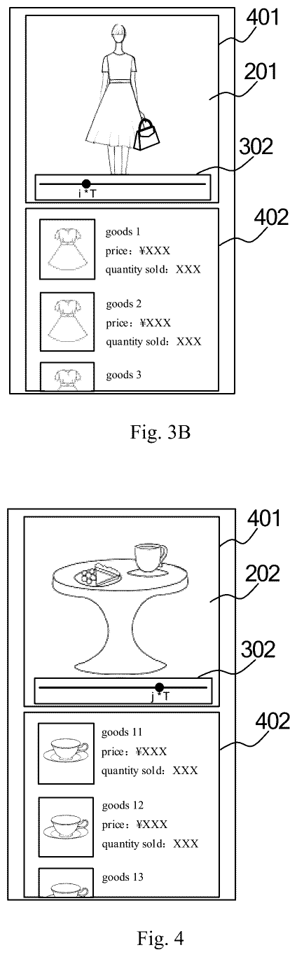

FIG. 3A is a schematic diagram of a second page provided by some embodiments of the present disclosure. As shown in FIG. 3A, for example, the second page may include an image display region 401 and a resource information region 402, the image frame 201 is displayed in the image display region 401, and the first resource information is displayed in the resource information region 402. For example, the image display region 401 displays a static image frame instead of a dynamic target video.

For example, the image display region 401 and the resource information region 402 may be arranged in a vertical direction of the second page as shown in FIG. 3A, that is, in the up-down direction as shown in the figure. In other embodiments, the image display region 401 and the resource information region 402 may be arranged in a horizontal direction of the second page. In other embodiments, the image display region 401 and the resource information region 402 may be at least partially overlapped, for example, the resource information region 402 may cover a partial region of the image display region 401. The positional relationship between the image display region 401 and the resource information region 402 may be determined according to actual requirements, and the embodiment of the present disclosure is not limited to this.

For example, in step S130, in the case where the user wants to perform image recognition and search operation on another image frame in the target video after viewing the first resource information, the user may trigger a second event for adjusting the playing progress of the target video in the second page. Although the image display region 401 displays a static image frame instead of a dynamic target video, the image display region 401 may be configured to be able to change the displayed image frame in response to the operation for adjusting the progress.

FIG. 3B is a schematic diagram of another second page provided by some embodiments of the present disclosure. As shown in FIG. 3B, for example, the second page further includes a progress bar control 501. The second event in step S130 may include: triggering a second predetermined operation on the progress bar control 501 of the second page to change progress information of the progress bar control 501. The image frame displayed in the image display region 401 is the image frame corresponding to the progress information of the target video.

For example, the second predetermined operation may be a swipe operation. In a case that a total duration of the target video is T and the progress information corresponding to the first image frame 201 is i*T (i is a numerical value greater than or equal to 0 and less than or equal to 1), when the progress information of the progress bar control 501 is changed to j*T (j is a numerical value greater than or equal to 0 and less than or equal to 1, j≠i) after a swipe operation is performed on the progress bar control 501, an image frame corresponding to the progress information j*T in the target video may be acquired as a second image frame. In addition, the second predetermined operation may also be a click operation, a double-click operation, etc., and the embodiment of the present disclosure does not limit the specific form of the second predetermined operation.

For example, in other examples, the second event may include a long press operation on the image display region 401, the progress information is determined by the duration of the long press operation, and after the long press operation is completed, the image frame in the image display region 401 is switched to an image frame matched with the progress information. For example, by performing a long press operation on a right half region of the image display region 401, a switch from the current image frame 201 to an image frame (i.e., the second image frame) located after the first image frame 201 is made. By performing a long press operation on a left half of the image display region 401, a switch from the current first image frame 201 to an image frame located in front of the first image frame 201 is made.

For example, in other examples, the second event may include performing a horizontal swipe operation (e.g., swipe left or right) on the image display region 401, and in response to the horizontal swipe operation on the image display region 401, a switch from the first image frame 201 to another image frame (i.e., the second image frame) in the target video is made.

FIG. 4 is a schematic diagram of another second page provided by some embodiments of the present disclosure. As shown in FIG. 4, for example, in response to a second event, the image frame displayed in the image display region 401 is switched into the image frame 202, and the image frame 202 may be an example of the “second image frame” of the present disclosure. Then, the image recognition and search operation may be performed on the image frame 202. For example, the terminal device may send the image frame 202 to the server, and the server performs the image recognition and search operation on the image frame 202 to obtain the second resource information. The details of an execution process of the image recognition and search operation may refer to the above-mentioned image recognition and search operation on the image frame 201, which will not be repeated here.

For example, in step S140, as shown in FIG. 4, after receiving the second resource information fed back by the server, the terminal device may display the second resource information in the resource information region 402 of the second page.

According to the video-based information display method provided by the embodiment of the present disclosure, after the image recognition and search operation on one image frame is triggered in the process of playing the target video and the display page (i.e. the second page) is entered, when the image recognition and search operation on the other image frame is to be performed, the image recognition and search operation on the other image frame may be triggered by directly performing the operation of switching the image frame in the display page without returning to the target video playing page (i.e., the first page). Based on this way, the operation flow may be simplified, the efficiency may be improved, and the user experience may be improved when the image recognition and search are required for different image frames of the video.

For example, when the user wants to acquire the resource information corresponding to other image frames except the image frame 201 and the image frame 202, the user may perform the second event in the second page again, so that the image display region 401 is switched from the image frame 202 to another image frame, to trigger the image recognition and search operation for the another image frame, and display resource information matched with the another image frame in the resource information region 402.

For example, the acquiring second resource information corresponding to a target object in the second image frame in step S130 further includes: acquiring the second resource information corresponding to the target object in the second image frame in response to the second image frame being displayed in the image display region for a predetermined length of time or receiving a third predetermined operation performed on the second image frame. The third predetermined operation may be a click operation or a double-click operation.

For example, in one example, after the image frame in the image display region 401 is switched into the image frame 202, the image recognition and search operation on the image frame 202 may be performed when certain conditions are satisfied, to confirm that the user really wants to acquire the second resource information matched with the image frame 202, thereby avoiding misoperation. For example, in some examples, the second resource information may be acquired and displayed when the second image frame 202 is displayed in the image display region 401 for a predetermined length of time. The predetermined length of time may be in the range of 1 second to 10 seconds, for example, 3 seconds. In other examples, after the image frame display region 401 is switched into the second image frame 202, the user needs to perform a predetermined operation on the second page to confirm the user intention. For example, after detecting the predetermined operation such as a click or a double-click on the image frame 202 by the user, it may be confirmed that the user really wants to acquire the second resource information matched with the image frame 202, and then the second resource information may be acquired and displayed. Based on this way, the user intention may be further determined after switching image frames, so as to confirm whether the user really wants to perform the image recognition and search operation on the second image frame, thereby avoiding invalid operations.

For example, in some embodiments, the video-based information display method may further include: increasing a display size of the resource information region 402 in a first direction and reducing a display size of the image display region in the first direction in response to receiving a fifth predetermined operation on the resource information region 402, so as to increase the second resource information displayed in the resource information region; and reducing the display size of the resource information region 402 in the first direction in response to receiving a sixth predetermined operation on the resource information region 402. The first direction may be parallel to a side line of the second page.

For example, as shown in FIGS. 3B and 4, the resource information region 402 is located below the image display region 401. In this case, the fifth predetermined operation may be a swipe-up operation. After the swipe-up operation on the resource information region 402 is detected, an upper edge of the resource information region 402 may be moved upward from the illustrated position to increase the size of the resource information region 402 in the vertical direction, so as to display more resource information in the resource information region 402. When the size of the resource information region 402 in the vertical direction is increased, the size of the image display region 401 in the vertical direction may be correspondingly reduced, or the resource information region 402 may cover a partial region of the image display region 401 without reducing the size of the image display region 401. The sixth predetermined operation may be a swipe-down operation. When the resource information region 402 is in an increased state, upon detecting the swipe-down operation on the resource information region 402, the upper edge of the resource information region 402 may be restored to the illustrated position to restore the size of the resource information region 402 in the vertical direction. Correspondingly, the size of the image display region 401 may be increased or the resource information region 402 may no longer cover the image display region 401. In addition, by performing a swipe operation on the resource information region 402, a plurality of pieces of resource information in the resource information region 402 may be moved up or down so that the displayed resource information is changed.

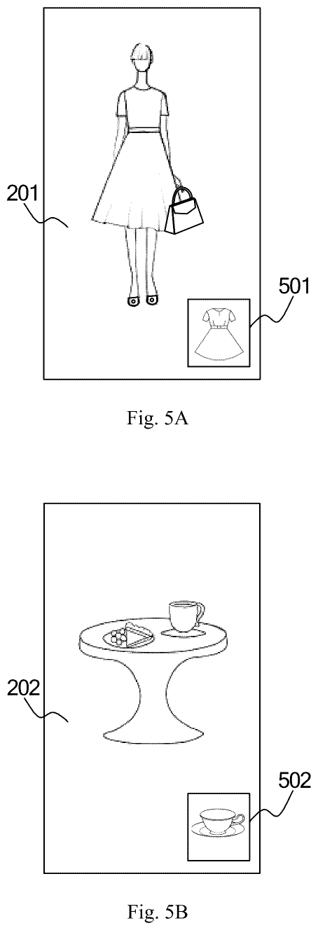

FIG. 5A is a schematic diagram of another first page provided by some embodiments of the present disclosure. As shown in FIG. 5A, for example, in some embodiments, the video-based information display method may further include: in the process of playing the target video, sequentially displaying, on the first page, N pieces of third resource information 501 corresponding to N key image frames of the target video, the N pieces of third resource information 501 are obtained in advance by matching based on the target object in the N key image frames, and N is an integer greater than 0.

For example, after the target video is uploaded to the server of the platform, the server may perform the recognition and search operation on at least some image frames (that is, N key image frames) in the target video, and the recognition and search operation may be performed with a permission from the user. For example, the key image frame may be an image frame whose picture difference with its previous image frame exceeds a certain threshold, and the picture difference between different image frames may be determined by the difference of pixel values at a plurality of corresponding positions in different image frames.

For example, the recognition and search operation on each key image frame may refer to the above-mentioned recognition and search operation on the image frame 201, which will not be repeated here. For each key image frame, K pieces of resource information may be determined, and the K pieces of resource information are taken as the third resource information corresponding to the key image frame, where K is an integer greater than or equal to 1. For example, a target object is recognized for a certain key image frame, and a piece of matched resource information is searched for the target object, then the piece of resource information may be used as the third resource information corresponding to the key image frame.

For example, in the process of playing the target video on the first page, the resource information 501 may be displayed in the first display region, the first display region may be a box region represented by a reference numeral 301, and the resource information 501 may be an example of the “third resource information” of the present disclosure. The resource information 501 may be implemented as an interface control. When a predetermined operation (for example, a click) is triggered for the resource information 501, the page may switch to a details page corresponding to the resource information 501.

For example, a plurality of pieces of resource information about the target video may be obtained offline by the server in advance before playing the target video. Thereafter, in the process of playing the target video by the terminal device, a plurality of pieces of resource information may be displayed on the playing page of the target video, so that the user may obtain relevant resource information of the target video without an additional search operation. Moreover, in a case that the user does not trigger the online recognition and search operation, the resource information recognized and searched offline is displayed to the user, and after the user triggers the recognition and search operation for the image frame of interest, resource information matched with the image frame of interest to the user may be acquired online. Off-line recognition can be combined with on-line recognition to enrich the image recognition and search function for the video, thereby improving the user experience.

For example, when the N key image frames are sequentially displayed in the first page, N pieces of third resource information are sequentially displayed in the first display region.

FIG. 5B is a schematic diagram of another first page provided by some embodiments of the present disclosure. As shown in FIGS. 5A and 5B, the N pieces of third resource information may include resource information 301 corresponding to the image frame 201 shown in FIG. 5A and resource information 302 corresponding to the image frame 202 shown in FIG. 5B. The resource information 301 may be displayed in the first page when the playing page is played to the image frame 201, and the resource information 302 may be displayed in the first page when the playing page is played to the image frame 202. That is to say, when the playing page is played to each of the N key image frames, the third resource information matched with the key image frame is displayed on the first page. The displayed third resource information will change with the change of the playing progress. Based on this way, the third resource information may correspond to the image frame in the playing page, and the interface may be more concise.

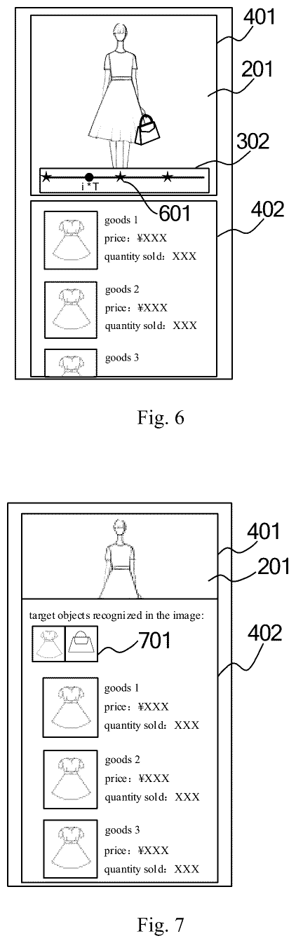

FIG. 6 is a schematic diagram of another second page provided by some embodiments of the present disclosure. As shown in FIG. 6, for example, the progress bar control includes N key points 601, and the progress information indicated by the N key points 601 corresponds to N key image frames respectively. Because the key image frame is greatly different from its previous image frame, there is a high probability that a new target object appears in each key image frame. By marking position points of the key image frames in the progress bar control, the user can know the position of the new target object through the progress bar control, helping the user to accurately locate the image frame of interest in a process of pulling the progress bar.

For example, in some examples, the triggering a first event on a first page playing a target video in step S110 may include: triggering a playing pause operation on the target video in response to the first event.

For example, the first event may be an event that can trigger a play pause, and the play pause may be triggered, for example, by clicking on a pause key or by clicking on a certain region of the playing page. In the process of playing the target video, in the case where the user is interested in a target object in a certain image frame, the user may pause the target video, which can trigger the online recognition and search operation on the image frame.

For example, in some examples, the triggering a first event on a first page playing a target video in step S110 may include: triggering a screenshot operation on the first page playing the target video in response to the first event.

For example, the first event may be an event that can trigger a screenshot, and the screenshot may be triggered, for example, by pressing a specific key. In the process of playing the target video, in the case where the user is interested in a target object in a certain image frame, the user may perform the screenshot operation, which can trigger the online recognition and search operation on the image frame.

For example, the three ways for triggering the first event on the first page (namely, using the first control, the pause and the screenshot) described above are simple and easy to operate and implement, and the ways for triggering the online recognition and search operation may be more diversified to adapt to the different operation habits of different users, thereby improving the user experience.

FIG. 7 is a schematic diagram of another second page provided by some embodiments of the present disclosure. As shown in FIG. 7, for example, the image frame 201 includes E target objects, and the first resource information includes E pieces of first sub-resource information respectively corresponding to the E target objects. The resource information region 401 includes E controls 701 respectively corresponding to E pieces of first sub-resource information. The control 701 is an example of a “second control” in the present disclosure, and each control 701 is configured to trigger an operation of displaying the first sub-resource information corresponding to the control 701 in the resource information region 401, E is an integer greater than 0.

For example, two target objects, namely a skirt and a bag, are recognized for the image frame 201, and a plurality of pieces of first sub-resource information may be searched for each target object. The second page may include two controls 701 respectively corresponding to the two target objects, and a plurality of pieces of corresponding first sub-resource information may be displayed in the resource information region 402 by clicking on each control 701. For example, when the control 701 corresponding to the target object “skirt” is clicked on, a plurality of pieces of first sub-resource information matched with the target object “skirt” may be displayed in the resource information region 402. When the control 701 corresponding to the target object “bag” is clicked on, a plurality of pieces of first sub-resource information matched with the target object “bag” may be displayed in the resource information region 402. Based on this way, the first sub-resource information corresponding to different types of target objects may be displayed separately, which is convenient for the user to search for resource information of interest.

For example, in some embodiments, the video-based information display method may further include: receiving a box selection operation on the second image frame in response to a failure of executing an operation of acquiring the second resource information or a failure of acquiring the second resource information within a predetermined length of time from triggering the second event; acquiring fourth resource information corresponding to a target object in the image region based on an image region defined by the box selection operation in response to receiving the box selection operation; and displaying the fourth resource information in the resource information region.

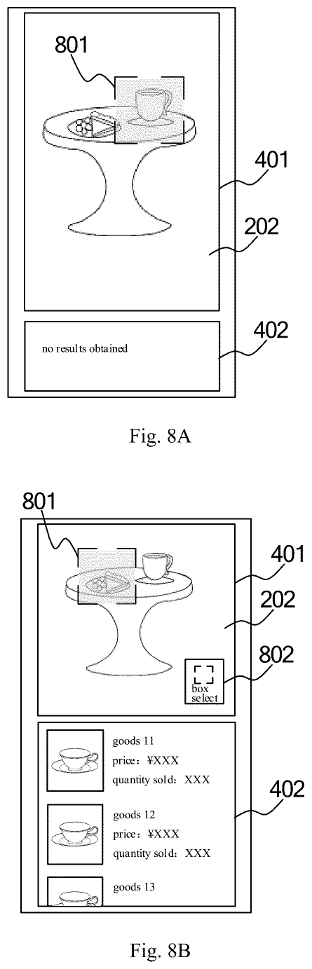

FIG. 8A is a schematic diagram of another second page provided by some embodiments of the present disclosure. As shown in FIG. 8A, for example, after the image in the image display region 401 is switched into the image frame 202, in a case where a result of the second resource information fed back by the server is empty (that is, the target object in the image frame 202 is not recognized or the second resource information matched with the target object in the image frame 202 is not searched), or feedback information from the server for the second resource information has not been received for a long time, a selection box 801 shown in FIG. 8A may be displayed, and the user may perform manual box selection on the region of interest. The selection box 801 can be dragged, zoomed in or zoomed out. The terminal device may send the image region corresponding to the selection box 801 to the server to inform the server to perform the recognition and search operation on the image region. After the terminal device receives the target object and the fourth resource information corresponding to the image region, the fourth resource information may be displayed in the resource information region 402. Based on this way, the recognition range may be narrowed to a more accurate range by performing manual box selection on the image region, which can speed up the recognition and improve the recognition accuracy to a certain extent.

For example, in some embodiments, the above-mentioned box selection operation may also be performed on the first image frame (e.g., the image frame 201). For example, in the case where the operation of acquiring the first resource information fails or the first resource information is not acquired within the predetermined length of time from the start of triggering the first event, the box selection operation on the first image frame is received; and in response to receiving the box selection operation, resource information corresponding to the target object in the image region is acquired based on the image region defined by the box selection operation.

FIG. 8B is a schematic diagram of another second page provided by some embodiments of the present disclosure. As shown in FIG. 8B, for example, the second page further includes a box selection control 802. In some embodiments, the information display method may further include: receiving a box selection operation on the second image frame 202 in response to receiving a fourth predetermined operation on the box selection control 802; acquiring fourth resource information corresponding to a target object in the image region based on the image region defined by the box selection operation in response to receiving the box selection operation; and displaying the fourth resource information in the resource information region 402. The fourth predetermined operation may be a click operation, a double-click operation and other operations.

For example, the image display region 401 may be provided with the box selection control 802 for triggering a box selection function. In the case where the user does not find the item of interest after viewing the second resource information matched with the image frame 202 in the resource information region 402, the user may click on the box selection control 802 to trigger the box selection function and display the selection box 801, so that the user can perform manual box selection on the region of interest. Based on this way, in a case that the target object of interest to the user is not automatically recognized, the user may perform the manual box selection on the region of interest, so that the user requirements are accurately located, and the recognition accuracy is improved.

For example, in some embodiments, the video-based information display method may further include: in a process of acquiring the second resource information, displaying the second image frame in the image display region, and displaying a dynamic scanning graphic superimposed on the second image frame, the dynamic scanning graphic includes a first scanning graphic moving in a predetermined direction and/or a second scanning graphic moving or flashing at a position of the target object in the second image frame.

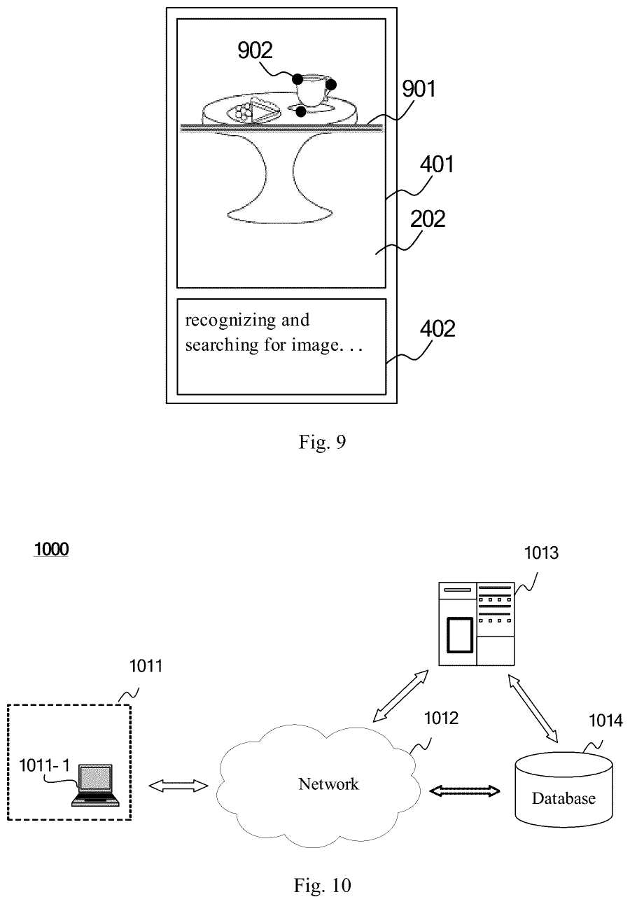

FIG. 9 is a schematic diagram of another second page provided by some embodiments of the present disclosure. As shown in FIG. 9, for example, after the image display region 401 is switched into the image frame 202, while waiting for the server to perform the recognition and search operation, a scanning graphic 901 may be displayed in the image display region 401; the scanning graphic 901 may be an example of the “first scanning graphic” of the present disclosure; and the scanning graphic 901 may move in the predetermined direction (e.g., an up-down direction as illustrated) to present a scanning effect. After the server determines second sub-resource information matched with various target objects of the image frame 202, the server may send each second sub-resource information and position information of each target object to the terminal device, the terminal device may display the scanning graphic 902 at a position where each target object is located, and the scanning graphic 902 may be an example of the “second scanning graphic” in the present disclosure. The scanning graphic 902 may be presented in a dynamic manner such as moving or flashing to indicate that the target objects are found at these positions and relevant resource information is searched, and then the second resource information may be presented in the resource information region 402.

For example, the first scanning graphic may be linear, curved, box-shaped, dotted and so on, and may be specifically set according to actual requirements, which is not limited by the embodiment of the present disclosure. The first scanning graphic may move in the up-down direction, or in a left-right direction, or in an oblique direction. In addition to adopting a change mode of moving, in other examples, the change mode of the first scanning graphic may be rotating, flashing, deforming, etc.

It is noted that in the embodiment of the present disclosure, the execution order of the various steps of the video-based information display method is not limited, and although the execution process of the various steps is described in a specific order above, this does not constitute a limitation to the embodiment of the present disclosure. The various steps in the video-based information display method may be executed in series or in parallel, which may be determined according to actual requirements. The video-based information display method may further include more or fewer steps, for example, by adding some preprocessing steps to achieve a better display effect, or by storing some intermediate process data for subsequent processing and calculation to omit some similar steps.

FIG. 10 is a system that may be used to implement the video-based information display method provided by the embodiment of the present disclosure. As shown in FIG. 10, the system 1000 may include one or more user terminals (i.e., terminal devices) 1011, a network 1012, a server 1013 and a database 1014. For example, the system 1010 may be used to implement the video-based information display method provided by any embodiment of the present disclosure.

The user terminal 1011 is a computer 1011-1, for example. It can be understood that the user terminal 1011 may be any other type of electronic device capable of performing data processing, which may include, but is not limited to, a desktop computer, a notebook computer, a tablet computer, a workstation and the like. The user terminal 1011 may also be any equipment provided with an electronic device. The embodiments of the present disclosure do not limit hardware configuration or software configuration of the user terminal (for example, the type (such as Windows, MacOS, Android, Harmony OS, etc.) or version of an operating system).

The user may operate an application installed on the user terminal 1011 or a website registered on the user terminal 1011, and the application or website transmits data such as image frames and requests to the server 1013 through the network 1012, and the user terminal 1011 may receive the data transmitted by the server 1013 through the network 1012.

For example, software with a video playing function is installed on the user terminal 1011, and the user plays the target video on the user terminal 1011 by using the video playing function of the software. The user terminal 1011 executes the video-based information display method provided by the embodiment of the present disclosure by running code.

The network 1012 may be a single network, or a combination of at least two different networks, which may be wireless communication networks, wired communication networks, etc. For example, the network 1012 may include, but not limited to, one or a combination of a local area network, a wide area network, a public network, private network, etc.

The server 1013 may be a standalone server, a server group, or a cloud server, and all servers in the server group are connected through wired or wireless networks. The server group may be centralized, such as a data center, or distributed. The server 1013 may be local or remote.

The database 1014 may generally refer to a device with a storage function. The database 1014 is mainly used for storing various data used, generated and outputted by the user terminal 1011 and the server 1013 in running, and may be various types of databases, such as a relational database or a non-relational database. The database 1014 may be local or remote. The database 1014 may include corresponding operating software and various memories, such as random access memory (RAM) and read only memory (ROM). Storage devices mentioned above are just some examples, and the storage devices that may be used by the system 1010 are not limited to this.

The database 1014 may be in interconnection or communication with the server 1013 or a part of the server 1013 via the network 1012; or in direct interconnection or communication with the server 1013; or a combination of the above two modes may be adopted.

In some examples, the database 1014 may be a stand-alone device. In other examples, the database 1014 may also be integrated in at least one of the user terminal 1011 and the server 1013. For example, the database 1014 may be provided on the user terminal 1011 or the server 1013. For another example, the database 1014 may also be distributed, with one part being provided on the user terminal 1011 and the other part being provided on the server 1013.

For example, a target video or the like may be deployed on the database 1014. When the terminal device needs to play the target video, the user terminal 1011 accesses the database 1014 through the network 1012 and acquires the target video stored in the database 1014 through the network 1012. The embodiment of the present disclosure does not limit the type of database, for example, the database may be a relational database or a non-relational database.

At least one embodiment of the present disclosure further provides a video-based information display apparatus. With the adoption of the apparatus, after the image recognition and search operation on one image frame is triggered in the process of playing the target video and the display page is entered, when the image recognition and search operation on the other image frame is to be performed, the image recognition and search operation on the other image frame may be triggered by directly performing the operation of switching the image frame in the display page without returning to the target video playing page. Based on this way, the operation flow may be simplified and the user experience may be improved when the image recognition and search function is required for different image frames of the video.

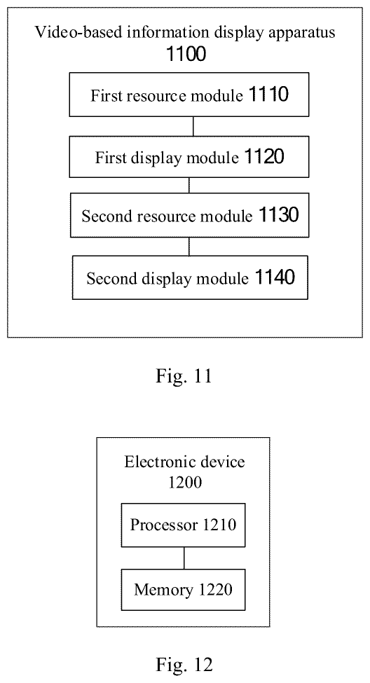

FIG. 11 is a schematic block diagram of a video-based information display apparatus provided by some embodiments of the present disclosure. As shown in FIG. 11, the video-based information display apparatus 1100 includes a first resource module 1110, a first display module 1120, a second resource module 1130 and a second display module 1140. For example, the video-based information display apparatus 1100 may be applied to the user terminal, and may also be applied to any device or system that needs to implement video playing and the recognition and search function, and the embodiment of the present disclosure does not limit this.

The first resource module 1110 is configured to, in response to triggering a first event on a first page playing a target video, acquire first resource information corresponding to a target object in a first image frame based on at least one first image frame that is played in a process of triggering the first event. For example, the first resource module 1110 may perform step S110 of the video-based information display method as shown in FIG. 1.

The first display module 1120 is configured to switch to a second page, the second page includes an image display region and a resource information region, the first image frame is displayed in the image display region, and the first resource information is displayed in the resource information region. For example, the first display module 1120 may perform step S120 of the video-based information display method as shown in FIG. 1.

The second resource module 1130 is configured to, in response to triggering, on the second page, a second event for adjusting a playing progress of the target video, switch from displaying the first image frame in the image display region to displaying a second image frame of the target video in the image display, and acquire second resource information corresponding to a target object in the second image frame. For example, the second resource module 1130 may perform step S130 of the video-based information display method as shown in FIG. 1.

The second display module 1140 is configured to display the second resource information in the resource information region. For example, the second display module 1140 may perform step S140 of the video-based information display method as shown in FIG. 1.

For example, the first resource module 1110, the first display module 1120, the second resource module 1130 and the second display module 1140 may be hardware, software, firmware and any feasible combination thereof. For example, the first resource module 1110, the first display module 1120, the second resource module 1130 and the second display module 1140 may be dedicated or universal circuits, chips or apparatuses, or may be a combination of a processor and a memory. The embodiment of the present disclosure does not limit the specific implementation forms of the first resource module 1110, the first display module 1120, the second resource module 1130 and the second display module 1140.

It should be noted that in the embodiment of the present disclosure, the respective units of the video-based information display apparatus 1100 correspond to the respective steps of the above-mentioned video-based information display method. Specific functions of the video-based information display apparatus 1100 may be referred to the above-mentioned description of the video-based information display method, and no details will be repeated here. Components and structures of the video-based information display apparatus 1100 shown in FIG. 11 are only exemplary, and not intended to be limiting, and the video-based information display apparatus 1100 may further include other components and structures as required.

For example, in some examples, the first resource module 1110 is further configured to perform at least one of the following operations: triggering a first predetermined operation on a first control of the first page in a process of playing the target video; triggering a playing pause operation on the target video in response to the first event; and triggering a screenshot operation on the first page playing the target video in response to the first event.

For example, in some examples, the second page further includes a progress bar control. The second resource module 1130 is further configured to: trigger a second predetermined operation on the progress bar control of the second page to change progress information of the progress bar control, the image frame displayed in the image display region is an image frame corresponding to the progress information in the target video.

For example, in some examples, the video-based information display apparatus may further include a third resource module, the third resource module is configured to: in the process of playing the target video, sequentially display, on the first page, N pieces of third resource information corresponding to N key image frames of the target video, the N pieces of third resource information are obtained in advance by matching based on the target objects in the N key image frames, and N is an integer greater than 0.

For example, in some examples, the progress bar control includes N key points, and the progress information indicated by the N key points corresponds to N key image frames respectively.

For example, in some examples, the first image frame includes E target objects, and the first resource information includes E pieces of first sub-resource information respectively corresponding to the E target objects. The resource information region includes E second controls respectively corresponding to the E pieces of first sub-resource information, and each of the second controls is configured to trigger an operation of displaying the first sub-resource information corresponding to the second control in the resource information region, E is an integer greater than 0.

For example, in some examples, the second resource module is further configured to: acquire the second resource information corresponding to the target object in the second image frame in response to the second image frame being displayed in the image display region for a predetermined length of time or receiving a third predetermined operation performed on the second image frame.

For example, in some examples, the video-based information display apparatus further includes a first box selection module, the first box selection module is configured to: receive a box selection operation on the second image frame in response to a failure of executing an operation of acquiring the second resource information or a failure of acquiring the second resource information within a predetermined length of time from triggering the second event; acquire fourth resource information corresponding to the target object in the image region based on the image region defined by the box selection operation in response to receiving the box selection operation; and display the fourth resource information in the resource information region.

For example, in some examples, the second page further includes a box selection control. The video-based information display apparatus further include a first box selection module, the first box selection module is configured to: receive a box selection operation on the second image frame in response to receiving a fourth predetermined operation on the box selection control; acquire fourth resource information corresponding to a target object in the image region based on an image region defined by the box selection operation in response to receiving the box selection operation; and display the fourth resource information in the resource information region.

For example, in some examples, the video-based information display apparatus further includes a scanning graphic module, the scanning graphic module is configured to: in a process of acquiring the second resource information, display the second image frame in the image display region, and display a dynamic scanning graphic superimposed on the second image frame, the dynamic scanning graphic includes a first scanning graphic moving in a predetermined direction and/or a second scanning graphic moving or flashing at a position of the target object in the second image frame.

For example, in some examples, the video-based information display apparatus further includes an adjustment module, the adjustment module is configured to: increase a display size of the resource information region in a first direction and reduce a display size of the image display region in the first direction in response to receiving a fifth predetermined operation on the resource information region, so as to increase the second resource information displayed in the resource information region; and reduce the display size of the resource information region in the first direction in response to receiving a sixth predetermined operation on the resource information region, the first direction is parallel to a side line of the second page.

FIG. 12 is a schematic block diagram of an electronic device provided by some embodiments of the present disclosure. As shown in FIG. 12, the electronic device 1200 includes a processor 1210 and a memory 1220. The memory 1220 is configured to store non-temporary computer readable instructions (e.g., one or more computer program modules). The processor 1210 is configured to run the non-temporary computer readable instructions; and the non-temporary computer readable instructions, when run by the processor 1210, may execute one or more steps in the video-based information display method as described above. The memory 1220 and the processor 1210 may be interconnected through a bus system and/or other forms of connection mechanisms (not shown).

For example, the processor 1210 may be a Central Processing Unit (CPU), a Digital Signal Processor (DSP), or other form of processing unit having a data processing capability and/or a program execution capability, for example, a Field Programmable Gate Array (FPGA), etc.; for example, the Central Processing Unit (CPU) may be an X86, or ARM architecture, etc. The processor 1210 may be a general-purpose processor or a special-purpose processor, and may control other components in the electronic device 1200 to execute desired functions.

For example, the memory 1220 may include any combination of one or more computer program products; and the computer program products may include various forms of computer readable storage media, for example, a volatile memory and/or a non-volatile memory. The volatile memory may include, for example, a Random Access Memory (RAM) and/or a cache, or the like. The non-volatile memory may include, for example, a Read Only Memory (ROM), a hard disk, an Erasable Programmable Read Only Memory (EPROM), a portable Compact Disk Read Only Memory (CD-ROM), a USB memory, a flash memory, or the like. One or more computer program modules may be stored on the computer readable storage medium, and the processor 1210 may run the one or more computer program modules, to implement various functions of the electronic device 1200. Various applications and various data, as well as various data used and/or generated by the applications may also be stored on the computer readable storage medium.

It should be noted that in the embodiments of the present disclosure, the above description of the video-based information display method may be referred to for specific functions and technical effects of the electronic device 1200, and no details will be repeated here.

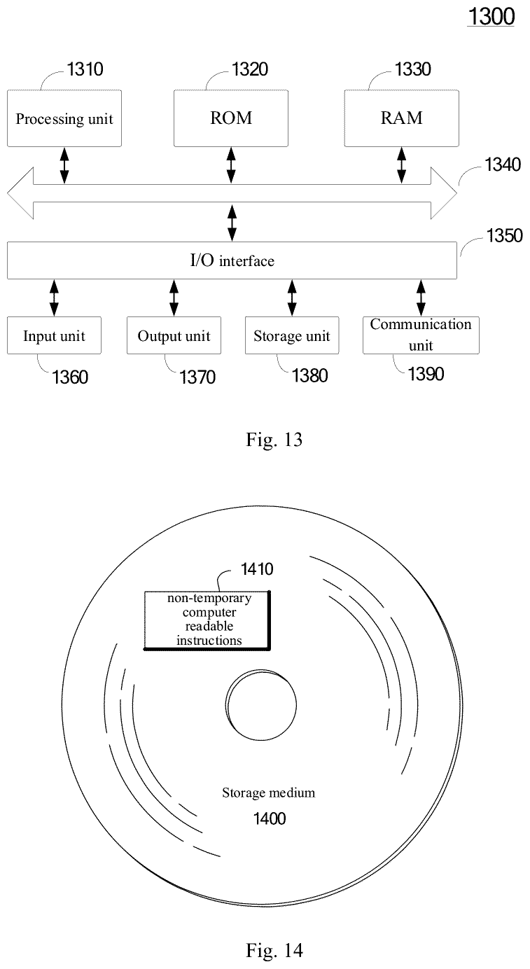

FIG. 13 is a schematic block diagram of another electronic device provided by some embodiments of the present disclosure. The electronic device 1300, for example, is suitable for implementing the video-based information display method provided by the embodiment of the present disclosure. The electronic device 1300 may be a user terminal, or the like. It should be noted that the electronic device 1300 shown in FIG. 13 is only an example and does not impose any limitations on the functionality and scope of use of the embodiments of the present disclosure.

As shown in FIG. 13, the electronic device 1300 may include the processing unit (e.g., a central processing unit (CPU), a graphics processing unit (GPU)) 1310, which may execute various appropriate actions and processing according to programs stored in the ROM 1320 or programs loaded to the RAM 1330 from the storage unit 1380. A plurality of programs and data required for the operation of the electronic device 1300 are also stored in the RAM 1330. The processing unit 1310, the ROM 1320 and the RAM 1330 are connected with each other through a bus 1340. An input/output (I/O) interface 1350 is also connected to the bus 1340.

In general, the following units may be connected to the I/O interface 1350: an input unit 1360 including a touch screen, a touch pad, a keyboard, a mouse, a camera, a microphone, an accelerometer, a gyroscope or the like; an output unit 1370 including a liquid crystal display (LCD), a loudspeaker, a vibrator or the like; a storage unit 1380 including a magnetic tape and a hard disk; and a communication unit 1390. The communication unit 1390 may allow the electronic device 1300 to communicate wirelessly in a wired manner with other electronic devices to exchange data. Although FIG. 13 shows the electronic device 1300 including a plurality of units, it should be understood that not all the shown units are required to be implemented or included. The electronic device 1300 may alternatively implement or include more or less units.

For example, according to the embodiments of the present disclosure, the video-based information display method shown in FIG. 1 may be implemented as computer software programs. For instance, the embodiment of the present disclosure provides a computer program product, which includes computer programs hosted on a non-transient computer readable medium. The computer programs contain program codes for executing the above video-based information display method, in such an embodiment, the computer programs may be unloaded and installed from the internet through the communication unit 1390, or installed from the storage unit 1380, or installed from the ROM 1320. The functions defined in the video-based information display method provided by the embodiment of the present disclosure are executed when the computer programs are executed by the processing unit 1310.

At least one embodiment of the present disclosure provides a storage medium, configured to store non-temporary computer readable instructions, the non-temporary computer readable instructions, when executed by a computer, implement the video-based information display method according to any embodiment of the present disclosure.

FIG. 14 is a schematic diagram of a storage medium provided by some embodiments of the present disclosure. As shown in FIG. 14, the storage medium 1400 is configured to store non-temporary computer readable instructions 1410. For example, the non-temporary computer readable instructions 1410, when executed by a computer, implement one or more steps of the video-based information display method according to the foregoing.

For example, the storage medium 1400 may be applied in the electronic device 1200 described above. For example, the storage medium 1400 may be the memory 1220 in the electronic device 1200 shown in FIG. 12. For example, a related description of the storage medium 1400 may be referred to the corresponding description of the memory 1220 in the electronic device 1200 shown in FIG. 12 and will not be repeated herein.

In the foregoing, a video-based information display method, a video-based information display apparatus, an electronic device, a storage medium, and a program product provided by embodiments of the present disclosure are described with reference to FIGS. 1 to 14.

It should be noted that the above storage medium (computer readable medium) of the present disclosure may be a computer readable signal medium, a non-transitory computer readable storage medium, or any combination of the above. The non-transitory computer readable storage medium, for instance, may be, but not limited to, electrical, magnetic, optical, electromagnetic, infrared, or semiconductor system, device, or equipment, or a combination of the above. A more specific example of the non-transitory computer readable storage medium may include but not limited to: electrical connection having one or more wires, portable computer disk, hard disk, RAM, ROM, erasable programmable read-only memory (EPROM), flash memory, optical fiber, portable compact disk read-only memory (CD-ROM), optical storage unit, magnetic storage unit, or any suitable combination of the above. In the present disclosure, the non-transitory computer readable storage medium may be any tangible medium containing or storing programs. The programs may be used by a command execution system, device or unit or used in combination with the command execution system, device or unit. However, in the present disclosure, the computer readable signal medium may include data signals propagated in baseband or as part of carrier, in which computer readable program codes are hosted. The propagated data signals may adopt a plurality of forms, including but not limited to electromagnetic signals, optical signals or any suitable combination of the above. The computer readable signal medium may also be any computer readable medium except the non-transitory computer readable storage medium. The computer readable signal medium can send, propagate or transmit programs used by the command execution system, device or unit or used in combination with the command execution system, device or unit. The program codes contained in the computer readable medium can be transmitted by any appropriate medium, including but not limited to: wire, optical cable, radio frequency (RF) and the like, or any suitable combination of the above.

In some embodiments, the client and the server may communicate by utilization of any network protocol which is currently known or developed in the future such as Hyper Text Transfer Protocol (HTTP), and may be interconnected with digital data communication (e.g., communication network) in any form or medium. The example of the communication network includes local area network (LAN), wide area network (WAN), internet, end-to-end network (e.g., ad hoc end-to-end network), and any network which is current known or developed in the future.

The above computer readable medium may be contained in the above electronic device and may also exist alone and not be assembled into the electronic device.

The above computer readable medium hosts one or more programs. When the above one or more programs are executed by the electronic device, the electronic device is configured to: in response to triggering a first event on a first page playing a target video, acquiring first resource information corresponding to a target object in the first image frame based on at least one first image frame played in a process of triggering the first event; switching to a second page, the second page includes an image display region and a resource information region, the first image frame is displayed in the image display region, and the first resource information is displayed in the resource information region; in response to triggering, on the second page, a second event for adjusting a playing progress of the target video, switching from displaying the first image frame in the image display region to displaying a second image frame of the target video in the image display region, and acquiring second resource information corresponding to a target object in the second image frame; and displaying the second resource information in the resource information region.

Computer program codes for performing the operations of the present disclosure may be written in one or more programming languages or a combination thereof. The above programming languages include but not limited to object-oriented programming languages such as Java, Smalltalk and C++, and also include conventional procedural programming languages such as “C” language or similar programming languages. The program codes may be completely executed on a user computer, partially executed on the user computer, executed as a separate package, partially executed on the user computer and partially executed on a remote computer, or completely executed on the remote computer or the server. In the case where the remote computer is involved, the remote computer may be connected to the user computer through any kind of network, such as a Local Area Network (LAN) or a Wide Area Network (WAN), or, alternatively, may be connected to an external computer (for instance, connected via the Internet by utilization of Internet service providers).

The flowcharts and the block diagrams in the drawings show possible architectures, functions and operations of the system, the method and the computer program product according to the embodiments of the present disclosure. In this regard, each block in the flowchart or the block diagram may represent a module, a program segment, or a part of code. The module, the program segment, or the part of the code contains one or more executable instructions for implementing specified logic functions. It should be also noted that in some alternative implementations, the functions marked in the blocks may also occur in a different order from those marked in the drawings. For instance, two consecutive blocks may actually be executed basically in parallel, and sometimes, may also be executed in a reverse order, determined by involved functions. It should be also noted that each block in the block diagram and/or the flowchart and the combination of the blocks in the block diagram and/or the flowchart may be implemented by a dedicated hardware-based system that performs a specified function or operation, and may also be implemented by the combination of a special hardware and computer instructions.

Units involved in the embodiments of the present disclosure may be implemented by software, and may also be implemented by hardware. The name of the unit should not define the unit under certain circumstances.

The functions described above in this document may be at least partially executed by one or more hardware logical units. For instance, without limitation, demonstration type hardware logical units that may be used include: field programmable gate array (FPGA), application-specific integrated circuit (ASIC), application specific standard parts (ASSP), system on a chip (SOC), complex programmable logic device (CPLD), etc.

In the present disclosure, the machine readable medium may be a tangible medium and may include or store programs used by command execution system, device or equipment or used in combination with the command execution system, device or equipment. The machine readable medium may be a machine readable signal medium or a machine readable storage medium. The machine readable medium may include but not limited to electronic, magnetic, optical, electromagnetic, infrared, or semiconductor system, device or equipment, or any suitable combination of the above. A more specific example of the machine readable storage medium may include electrical connection based on one or more wires, portable computer disk, hard disk, Random Access Memory (RAM), Read Only Memory (ROM), Erasable Programmable Read Only Memory (EPROM), flash memory, optical fiber, Convenient Compact Disk Read Only Memory (CD-ROM), optical storage unit, magnetic storage unit, or any suitable combination of the above.

The above description is only the explanation of a partial embodiment of the present disclosure and the used technical principle. It should be understood by those skilled in the art that the disclosure scope involved in the disclosure is not limited to the technical solution formed by the specific combination of the above technical features, but also covers other technical solutions formed by any combination of the above technical features or their equivalent features without departing from the above disclosed concept. For example, the technical solution formed by replacing the above features with (but not limited to) technical features with similar functions disclosed in the disclosure.

In addition, although the operations are depicted in a specific order, this should not be understood as requiring these operations to be performed in the specific order shown or in a sequential order. Under certain circumstances, multitasking and parallel processing may be beneficial. Similarly, although several specific implementation details are included in the above discussion, these should not be interpreted as limiting the scope of the present disclosure. Some features described in the context of separate embodiments may also be implemented in a single embodiment in combination. On the contrary, various features described in the context of a single embodiment may also be implemented in a plurality of embodiments alone or in any suitable sub-combination.

Although the subject matter has been described in language specific to structural features and/or logical actions of methods, it should be understood that the subject matter defined in the appended claims is not necessarily limited to the specific features or actions described above. On the contrary, the specific features and actions described above are only example forms of realizing the claims.

What is claimed is:

1. A video-based information display method, comprising:
in response to triggering a first event on a first page playing a target video, acquiring first resource information corresponding to a target object in a first image frame based on at least one first image frame played in a process of triggering the first event;
switching to a second page, wherein the second page comprises an image display region and a resource information region, the first image frame is displayed in the image display region, and the first resource information is displayed in the resource information region;
in response to triggering, on the second page, a second event for adjusting a playing progress of the target video, switching from displaying the first image frame in the image display region to displaying a second image frame of the target video in the image display region, and acquiring second resource information corresponding to a target object in the second image frame; and
displaying the second resource information in the resource information region.

2. The method according to claim 1, wherein the triggering a first event on a first page playing a target video comprises at least one of the following:
triggering a first predetermined operation on a first control of the first page in a process of playing the target video;
triggering a playing pause operation on the target video; and
triggering a screenshot operation on the first page playing the target video.

3. The method according to claim 1, wherein the second page further comprises a progress bar control;
the triggering, on the second page, a second event for adjusting a playing progress of the target video comprises: triggering a second predetermined operation on the progress bar control of the second page to change progress information of the progress bar control,
wherein the image frame displayed in the image display region is an image frame corresponding to the progress information in the target video.

4. The method according to claim 3, further comprising:
in the process of playing the target video, sequentially displaying, on the first page, N pieces of third resource information corresponding to N key image frames of the target video, wherein the N pieces of third resource information are obtained in advance by matching based on the target object in the N key image frames,
wherein N is an integer greater than 0.

5. The method according to claim 4, wherein the progress bar control comprises N key points, and the progress information indicated by the N key points respectively corresponds to the N key image frames.

6. The method according to claim 1, wherein the first image frame comprises E target objects, and the first resource information comprises E pieces of first sub-resource information respectively corresponding to the E target objects,
the resource information region comprises E second controls respectively corresponding to the E pieces of first sub-resource information, and each of the second controls is configured to trigger an operation of displaying the first sub-resource information corresponding to the second control in the resource information region,
wherein E is an integer greater than 0.

7. The method according to claim 1, wherein the acquiring second resource information corresponding to a target object in the second image frame comprises:
acquiring the second resource information corresponding to the target object in the second image frame in response to the second image frame being displayed in the image display region for a predetermined length of time or receiving a third predetermined operation performed on the second image frame.

8. The method according to claim 1, further comprising:
receiving a box selection operation on the second image frame in response to a failure of executing an operation of acquiring the second resource information or a failure of acquiring the second resource information within a predetermined length of time from triggering the second event;
acquiring fourth resource information corresponding to a target object in the image region based on an image region defined by the box selection operation in response to receiving the box selection operation; and
displaying the fourth resource information in the resource information region.

9. The method according to claim 1, wherein the second page further comprises a box selection control,
the information display method further comprises:
receiving a box selection operation on the second image frame in response to receiving a fourth predetermined operation on the box selection control;
acquiring fourth resource information corresponding to a target object in the image region based on an image region defined by the box selection operation in response to receiving the box selection operation; and
displaying the fourth resource information in the resource information region.

10. The method according to claim 1, further comprising:
in a process of acquiring the second resource information, displaying the second image frame in the image display region, and displaying a dynamic scanning graphic superimposed on the second image frame,
wherein the dynamic scanning graphic comprises a first scanning graphic moving in a predetermined direction and/or a second scanning graphic moving or flashing at a position of the target object in the second image frame.

11. The method according to claim 1, further comprising:
increasing a display size of the resource information region in a first direction and reducing a display size of the image display region in the first direction in response to receiving a fifth predetermined operation on the resource information region, so as to increase the second resource information displayed in the resource information region; and
reducing the display size of the resource information region in the first direction in response to receiving a sixth predetermined operation on the resource information region,
wherein the first direction is parallel to a side line of the second page.

12. A video-based information display apparatus, comprising:
a first resource module configured to, in response to triggering a first event on a first page playing a target video, acquire first resource information corresponding to a target object in a first image frame based on at least one first image frame that is played in a process of triggering the first event;
a first display module configured to switch to a second page, wherein the second page comprises an image display region and a resource information region, the first image frame is displayed in the image display region, and the first resource information is displayed in the resource information region;
a second resource module configured to, in response to triggering, on the second page, a second event for adjusting a playing progress of the target video, switch from displaying the first image frame in the image display region to displaying a second image frame of the target video in the image display, and acquire second resource information corresponding to a target object in the second image frame; and
a second display module configured to display the second resource information in the resource information region.

13. An electronic device, comprising:
a processor; and
a memory comprising one or more computer program modules;
wherein the one or more computer program modules are stored in the memory and configured to be executed by the processor, and the one or more computer program modules comprise instructions for implementing a video-based information display method, the video-based information display method comprises:
in response to triggering a first event on a first page playing a target video, acquiring first resource information corresponding to a target object in a first image frame based on at least one first image frame played in a process of triggering the first event;
switching to a second page, wherein the second page comprises an image display region and a resource information region, the first image frame is displayed in the image display region, and the first resource information is displayed in the resource information region;
in response to triggering, on the second page, a second event for adjusting a playing progress of the target video, switching from displaying the first image frame in the image display region to displaying a second image frame of the target video in the image display region, and acquiring second resource information corresponding to a target object in the second image frame; and
displaying the second resource information in the resource information region.

14. A computer-readable storage medium for storing non-transitory computer-readable instructions, the non-transitory computer-readable instructions, when executed by a computer, implement the video-based information display method according to claim 1.

15. (canceled)

16. The method according to claim 2, wherein the second page further comprises a progress bar control;
the triggering, on the second page, a second event for adjusting a playing progress of the target video comprises: triggering a second predetermined operation on the progress bar control of the second page to change progress information of the progress bar control,
wherein the image frame displayed in the image display region is an image frame corresponding to the progress information in the target video.

17. The method according to claim 2, wherein the first image frame comprises E target objects, and the first resource information comprises E pieces of first sub-resource information respectively corresponding to the E target objects,
the resource information region comprises E second controls respectively corresponding to the E pieces of first sub-resource information, and each of the second controls is configured to trigger an operation of displaying the first sub-resource information corresponding to the second control in the resource information region,
wherein E is an integer greater than 0.

18. The method according to claim 2, wherein the acquiring second resource information corresponding to a target object in the second image frame comprises:
acquiring the second resource information corresponding to the target object in the second image frame in response to the second image frame being displayed in the image display region for a predetermined length of time or receiving a third predetermined operation performed on the second image frame.

19. The method according to claim 2, further comprising:
receiving a box selection operation on the second image frame in response to a failure of executing an operation of acquiring the second resource information or a failure of acquiring the second resource information within a predetermined length of time from triggering the second event;
acquiring fourth resource information corresponding to a target object in the image region based on an image region defined by the box selection operation in response to receiving the box selection operation; and
displaying the fourth resource information in the resource information region.

20. The method according to claim 2, wherein the second page further comprises a box selection control,
the information display method further comprises:
receiving a box selection operation on the second image frame in response to receiving a fourth predetermined operation on the box selection control;
acquiring fourth resource information corresponding to a target object in the image region based on an image region defined by the box selection operation in response to receiving the box selection operation; and
displaying the fourth resource information in the resource information region.

21. The method according to claim 2, further comprising:
in a process of acquiring the second resource information, displaying the second image frame in the image display region, and displaying a dynamic scanning graphic superimposed on the second image frame,
wherein the dynamic scanning graphic comprises a first scanning graphic moving in a predetermined direction and/or a second scanning graphic moving or flashing at a position of the target object in the second image frame.
